(19) United States
(12) Patent Application Publication
(10) Pub. No.: US 2014/0278457 A1
(43) Pub. Date: Sep. 18, 2014

(54) Tracking Changes Between Versions Of Medical Device Data Sets

(71) Applicant: CAREFUSION 303, INC., San Diego, CA (US)

(72) Inventors: Aron Weiler, San Diego, CA (US); Tim Henderson, San Diego, CA (US)

(73) Assignee: CAREFUSION 303, INC., San Diego, CA (US)

(21) Appl. No.: 13/827,335

(22) Filed: Mar. 14, 2013

(51) Int. Cl. G06Q 50/22; G06Q 10/00

(52) U.S. Cl. CPC G06Q 50/22; G06Q 10/00
USPC 705/2

(57) ABSTRACT

The subject matter disclosed herein provides methods for comparing two data sets and generating a report based on the comparing. In one aspect, the method can include accessing an original data set having one or more fields and accessing a revised data having one or more corresponding fields. The original and revised data sets can include original and revised configuration setting, respectively, for one or more medical devices. The method can further include comparing the fields in the revised data set with the fields in the original data set and generating a report based on the comparing. This report can characterize the differences between the fields in the original data set and the revised data set and identify these differences with formatting representative of the difference. The method can further include providing data characterizing the report. Related apparatus, systems, techniques and articles are also described.

### TECHNICAL FIELD

The subject matter described herein relates to a software platform that compares data sets and generates a report that displays the differences between medical device data sets.

### BACKGROUND

Data sets define various configuration settings for medical devices and allow entities, such as caregivers and hospitals, to customize the operation of such medical devices. For example, a data set can define a series of therapies that can be implemented by an infusion pump. These therapies can have user-defined infusion rate limits for continuous or bolus infusions as well as other infusion types which, in turn, can vary based on the type of fluid/medication being delivered.

The ability to compare different versions of a data set and determine what has changed can arise in different scenarios. If, for example, an entity is developing a new version of a data set, he/she may want to know if a particular change has been implemented. Automatic comparison of the contents of the new version of the data set with the original data set can facilitate this determination. Data set comparison can also be useful in setting the limits or guardrails for a particular drug therapy. If, for example, an incident occurs that reveals that the infusion limits associated with a drug in a deployed data set are too wide, comparison of this data set with prior versions can allow the entity to determine how long these erroneous guardrails have been in place and how they should be adjusted.

### SUMMARY

In some implementations, methods and apparatus, including computer program products, and systems are provided for the comparing of an original data set with a revised data set and the generating of a report that identifies the differences between the original and revised data sets.

In one aspect, an original data set having one or more fields is accessed. The original data set includes an original configuration setting for one or more medical devices. In addition, a revised data set having one or more fields that correspond to the one or more fields in the original data set is accessed. The revised data set includes a revised configuration setting for the one or more medical devices. The one or more fields in the revised data set are compared with the one or more fields in the original data set. A report is generated based on the comparing. This report characterizes one or more differences between the one or more fields in the original data set and the one or more fields in the revised data set with formatting representative of the difference. Data characterizing the report is provided.

The above methods, apparatus, computer program products, and systems can, in some implementations, further include one or more of the following features.

The providing of data can include at least one of displaying the report, loading data characterizing the report, storing data characterizing the report, or transmitting data characterizing the report.

The one or more differences can include one or more new fields present in the revised data set that are absent from the original data set. The report can display the one or more new fields and a value associated with each of the one or more new fields. The formatting for the display of the one or more new fields and the value associated with each of the one or more new fields can include a predetermined background color.

The one or more differences can include one or more deleted fields absent from the revised data set that are present in the original data set. The report can display the one or more deleted fields and a value associated with each of the one or more deleted fields. The formatting for the display of the one or more deleted fields and the value associated with each of the one or more deleted fields can include strikethrough formatting.

Each of the one or more fields in the original data set can be associated with a value. Each of the one or more fields in the revised data set can be associated with a value. The comparing described above can further compare the value associated with each of the one or more fields in the revised data set with the value in the corresponding one or more fields in the original data set. The one or more differences can include a value change. The value change can indicate that the value associated with any of the one or more fields in the revised data set is different from the value in the corresponding one or more fields in the original data set. The report can display the value of the one or more fields in the revised data set associated with the value change with formatting representative of a value change. The formatting for the display of the value change can be a dark background with white text. The report can display information regarding the value change including one or more of an original value from the original data set, an entity that caused the value change, or a date and a time associated with the value change. This information can be displayed in a pop-up window when an entity hovers over or selects the value displayed with the formatting representative of the value change.

The one or more differences displayed in the report can be grouped into one or more care areas.

The original data set and the revised data set can further include drug libraries, clinical advisories, or channel label libraries for the one or more medical devices.

The accessing the original data set, the accessing the revised data set, the comparing, the generating, and the providing can be implemented in at least one data processor forming part of at least one computing system.

The above methods, apparatus, computer program products, and systems can also transmit the original data set and the revised data set to the one or more medical devices.

The above methods, apparatus, computer program products, and systems can also associate a username of an entity with a permission level and compare the permission level with a threshold permission level. If the permission level meets or exceeds the threshold permission level, then a menu for keeping or rejecting the one or more differences in the report can be displayed.

Computer program products are also described that comprise non-transitory computer readable media storing instructions, which when executed one or more data processor of one or more computing systems, causes at least one data processor to perform operations herein. Similarly, computer systems are also described that can include one or more data processors and a memory coupled to the one or more data processors. The memory can temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, the current subject matter provides an interface for comparing data sets and generating a track changes report that identifies the differences between the data sets.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated herein and constitute a part of this specification, show certain aspects of the subject matter disclosed herein and, together with the description, help explain some of the principles associated with the subject matter disclosed herein. In the drawings,

FIG. 1 is a system diagram illustrating a computing landscape within a healthcare environment;

FIG. 2 illustrates a graphical user interface of a data set editor application;

FIG. 3 illustrates a graphical user interface for generating a track changes report;

FIG. 4A illustrates a track changes report;

FIG. 4B illustrates a menu that allows an entity to keep or reject changes identified in the track changes report; and

FIG. 5 illustrates a flowchart for comparing data sets and generating a track changes report based on the comparison.

Like reference symbols in the various drawings indicate like elements.

### DETAILED DESCRIPTION

The subject matter disclosed herein relates to the comparison of data sets and the generation of a report that identifies the differences between the data sets. This comparison can be useful in identifying any changes made to the fields of a data set as well as the values associated with each field. In some implementations, an entity having the appropriate permission level can accept or reject the changes made to a revised data set.

FIG. 1 is a system diagram illustrating a computing landscape 100 within a healthcare environment such as a hospital. Various devices and systems, both local to the healthcare environment and remote from the healthcare environment, can interact via at least one computing network 105. This computing network 105 can provide any form or medium of digital communication connectivity (i.e., wired or wireless) amongst the various devices and systems.

Aspects of computing landscape 100 can be implemented in a computing system that includes an application server 115. Application server 115 can run a data set editor application that can allow an entity to create or modify a data set and compare two data sets with each other. A data set can include configuration settings, drug libraries, clinical advisories, or channel label libraries for one or more medical devices 140A, 140B, and 140C. These data sets can be transmitted to medical devices 140A, 140B, and 140C. These data sets can also be stored at data storage 125 which can include databases that provide physical data storage or a cloud based system that provides remote data storage of these data sets. Application server 115 can have a graphical user interface or a Web browser through which an entity can interact with the data set editor application.

Various types of medical devices 140A, 140B, and 140C can be connected to network 105. These medical devices 140A, 140B, and 140C can comprise, unless otherwise specified, any type of device or system with a communications interface that characterizes one or more physiological measurements of a patient and/or that characterizes treatment of a patient. Data sets created using the editor application at application server 115 can be transmitted to medical devices 140A, 140B, and 140C via network 105.

FIG. 2 illustrates a graphical user interface 200 of a data set editor application. An entity can use graphical user interface 200 to create a data set, modify an existing data set, or generate a data set report. While the description of FIG. 2 is mainly directed to data sets for the distribution of medication using fluid infusion pumps, the current subject matter is also applicable to data sets for any type of medical device that gives an entity an ability to modify various configuration settings. The data set can contain various fields that specify the operational parameters for a medical device in one or more care areas. A care area can correspond to a department in a hospital including, for example, an intensive care unit (ICU), a pediatric intensive care unit (PICU), an emergency room (ER), and the like.

The data set illustrated in graphical user interface 200 can include various fields that serve as placeholders for the operational parameters of a medical device operating in PICU. These fields can identify the drugs used by the device and the corresponding concentration levels of each drug (column 205), whether these drugs can be infused continuously or via a bolus (column 210), the corresponding limits associated with these infusions (columns 215), and any applicable clinical advisories (column 220) associated with each drug. Each of these fields can have a corresponding value or no value at all. For example, in row 225, propofol is the value associated with drug name 205, and this drug can be infused continuously or via a bolus in accordance with the specified limit values 215.

An entity can use graphical user interface 200 to create a data set or modify the fields or values in an existing data set. Field modifications can affect the structure of a data set and can occur when a field is deleted or added. In the example of FIG. 2, an entity can, for example, delete a drug and its associated values from the data set (e.g., delete row 225) or add a new drug and its associated values to the data set. An entity can also modify the value associated with a field by selecting the value to be changed and entering a new value. For example, an entity can adjust the soft maximum limit for the continuous infusion of propofol in row 225 from 200 to 150.

An entity can save the changes made to an original data set in a new revised data set. The revised data set can be stored in data storage 125. Because the structure of the revised data set can be based on the original data set, the two data sets can have similar or corresponding fields.

An entity can also generate a data set report from graphical user interface 200. The data set report can identify the various fields and values that are included in the data set and can be presented in different formats including, for example, a table (as illustrated in FIG. 2), a list, and the like.

FIG. 3 illustrates a graphical user interface 300 for generating a track changes report. The track changes report can identify any differences associated with the fields and/or values in two data sets. An entity can designate the data sets to be compared by selecting an original data set in field 305A and a revised data set in field 305B. The data set editor application can access the selected data sets from data storage 125. The output format for the track changes report can be designated using field 310. Although the example of FIG. 3 designates Microsoft Word as the output format, other output formats can be used including, for example, a table, a presentation file, a text file, and the like. An entity can also use field 310 to print a track changes report. Because the data sets selected in fields 305A and 305B can contain a voluminous amount of information, an entity can narrow the amount of information to be compared by specifying one or more filters. These filters can be based on a care area 315, a drug library 320, and/or a particular configuration 325. Additional filters can be selected from “Other” section 330. Once the desired filters have been selected, the entity can press “Compare” button 335 to initiate the comparison process.

The data set editor application can compare data sets by examining the fields in the original and revised data sets and the values associated with these fields. Examination of the fields can reveal changes to the structure of the data set. These changes can include, for example, the addition of a new field to the revised data set that is absent from the original data set, or the deletion of a field from the original data set that is absent from the revised data set. Examination of field values can reveal, for example, value changes between the revised data set and the corresponding field in the original data set.

FIG. 4A illustrates a sample track changes report 400 that can display the changes described above. The fields and values displayed in track changes report 400 can be based on the information in the revised data set. Some of these fields and values can be displayed with different formatting to indicate one or more differences between the revised data set and the original data set. This formatting can facilitate quick visual identification of these changes. In some implementations, track changes report 400 can display only those fields or values that have changed. In these implementations, unmodified fields and values can be omitted from the report.

Track changes report 400 illustrates different examples of field and value modifications. A value change can be displayed by showing the edited value with a dark background and white text. In the example of FIG. 4A, the formatting associated with continuous infusion concentration limit values 406 and clinical advisory value 407 can indicate that the values for these fields in the revised data set are different from the values in the corresponding fields of the original data set. Other types of formatting can be used to represent a changed value including, for example, italicized text, the placement of a box or circle around the changed value, and the like. In some implementations, track changes report 400 can include a tooltip that display additional information regarding the value change. This information can include, for example, the original value from the original data set, the entity that caused the value change, or the date and time that the change was made. This tooltip can be displayed as a pop-up window that appears when an entity hovers over or selects the formatted value.

A deleted value can be represented with strikethrough formatting. For example, the concentration value 405 associated with “Drug Name 1” can be displayed with strikethrough formatting to indicate that this value appears in the original data set but is absent from the revised data set. Track changes report 400 can display a tooltip that indicates when the value was deleted and the entity that made the deletion. This tooltip can appear in a pop-up window when an entity hovers over or selects the formatted value.

New fields and their associated values can be displayed with a predetermined color background. In the example of FIG. 4A, “Drug Name 2” can be displayed with a white background to indicate that this drug was added to the revised data set. Track changes report 400 can display a tooltip that indicates when these fields and values were added to the revised data set and the entity that made these additions.

Deleted fields, like deleted values, can be displayed with strikethrough formatting. In the example of FIG. 4A, “Drug Name 3” can be displayed with strikethrough formatting to indicate that this field is absent from the revised data set and present in the original data set. In some implementations, a tooltip similar to the one described above with respect to a deleted value can display information regarding the deletion including the entity that caused the deletion and when the deletion was made.

Depending on an entity's permission level, an entity can accept or reject the changes displayed in track changes report 400. In some implementations, graphical user interface 300 can prompt an entity to enter a username 350 before generating track changes report 400. The data set editor application can associate the provided username 350 with a permission level. Permission levels can, for example, be stored in data storage 125. The data set editor application can compare the entity's permission level with a threshold permission level to determine if the entity has the appropriate authority to finalize the changes in track changes report 400. If the entity's permission level meets or exceeds the threshold permission level, then menu 450 illustrated in FIG. 4B can be used to finalize these changes. Menu 450 can appear when an entity with the appropriate permission level selects a formatted field or formatted text from track changes report 400. If the entity does not have the appropriate permission level, then menu 450 cannot be displayed.

Using menu 450, an entity can either reject (by selecting 460) or keep (by selecting 465) the selected change. If the change is rejected, then the data set editor application can revert the modified value or field in the revised data set back to its original state as saved in the original data set. If, however, the change is kept, then the selected field or value in the revised data set can remain unaffected.

FIG. 5 illustrates a flowchart 500 for comparing two data sets and generating a track changes report using a track changes editor application. At 505, the track changes editor application can access the original data set. In some implementations, an entity can use graphical user interface 300 to select original data set 305A. The original data set can be stored at data storage 125.

At 510, the track changes editor application can access the revised data set. Like the original data set, the revised data set can be selected from data storage 125 using graphical user interface 300. The revised data set can have one or more fields that correspond to the fields in the original data set.

At 515, the data set editor application can compare the fields in the revised data set with the fields in the original data set. This comparison can reveal, for example, the addition of a new field or the deletion of a field. In some implementations, this comparison can also compare the value associated with each of the fields in the revised data set with the value in the corresponding field in the original data set.

At 520, the data set editor application can generate a report based on the comparing performed at 515. This report can identify one or more differences between the revised data set and the original data set. These differences can be displayed with formatting representative of the difference. For example, an added field can be displayed with a predetermined color background; a deleted field or deleted value can be displayed with strikethrough formatting; and a changed or edited value can be displayed with a dark background and white text. The formatting style for each of these scenarios can be changed.

At 525, the data set editor application can provide the data characterizing the report. In some implementations, the providing can include displaying the data at a monitor, loading the data to a device connected to network 105, storing the data to data storage 125 or other device connected to the network, or transmitting the data to a device connected the network.

One or more aspects or features of the subject matter described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with an entity, the subject matter described herein can be implemented on a computer having a display device, such as for example a cathode ray tube (CRT) or a liquid crystal display (LCD) monitor for displaying information to the entity and a keyboard and a pointing device, such as for example a mouse or a trackball, by which the entity can provide input to the computer. Other kinds of devices can be used to provide for interaction with an entity as well. For example, feedback provided to the entity can be any form of sensory feedback, such as for example visual feedback, auditory feedback, or tactile feedback; and input from the entity can be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A computer-implemented method comprising:
accessing an original data set having one or more fields, the original data set including an original configuration setting for one or more medical devices;
accessing a revised data set having one or more fields that correspond to the one or more fields in the original data set, the revised data set including a revised configuration setting for the one or more medical devices;
comparing the one or more fields in the revised data set with the one or more fields in the original data set;
generating a report based on the comparing that characterizes one or more differences between the one or more fields in the original data set and the one or more fields in the revised data set, the one or more differences having formatting representative of the difference; and
providing data characterizing the report.

2. The method of claim 1, wherein the providing the data comprises at least one of: displaying the report, loading data characterizing the report, storing data characterizing the report, or transmitting data characterizing the report.

3. The method of claim 1, wherein the one or more differences includes one or more new fields present in the revised data set that are absent from the original data set, and
wherein the report displays the one or more new fields and a value associated with each of the one or more new fields.

4. The method of claim 3, wherein the formatting for the display of the one or more new fields and the value associated with each of the one or more new fields includes a predetermined background color.

5. The method of claim 1, wherein the one or more differences includes one or more deleted fields absent from the revised data set that are present in the original data set, and
wherein the report displays the one or more deleted fields and a value associated with each of the one or more deleted fields.

6. The method of claim 5, wherein the formatting for the display of the one or more deleted fields and the value associated with each of the one or more deleted fields is strikethrough formatting.

7. The method of claim 1, wherein each of the one or more fields in the original data set are associated with a value,
wherein each of the one or more fields in the revised data set is associated with a value,
wherein the comparing further compares the value associated with each of the one or more fields in the revised data set with the value in the corresponding one or more fields in the original data set,
wherein the one or more differences includes a value change, the value change indicating that the value associated with any of the one or more fields in the revised data set is different from the value in the corresponding one or more fields in the original data set, and
wherein the report displays the value of the one or more fields in the revised data set associated with the value change with formatting representative of a value change.

8. The method of claim 7, wherein the formatting for the display of the value change is a dark background with white text.

9. The method of claim 7, wherein the report further displays information regarding the value change, the information including one or more of an original value from the original data set, an entity that caused the value change, or a date and a time associated with the value change.

10. The method of claim 9, wherein the information is displayed in a pop-up window when the entity hovers over or selects the value displayed with the formatting representative of the value change.

11. The method of claim 1, wherein the one or more differences displayed in the report are grouped into one or more care areas.

12. The method of claim 1, wherein the original data set and the revised data set further comprise drug libraries, clinical advisories, or channel label libraries for the one or more medical devices.

13. The method of claim 1, further comprising:
transmitting the original data set and the revised data set to the one or more medical devices.

14. The method of claim 1, further comprising:
associating a username of an entity with a permission level;
comparing the permission level with a threshold permission level; and
displaying a menu for keeping or rejecting the one or more differences in the report if the permission level meets or exceeds the threshold permission level.

15. The method of claim 1, wherein the accessing the original data set, the accessing the revised data set, the comparing, the generating, and the providing are implemented in at least one data processor forming part of at least one computing system.

16. A non-transitory computer-readable medium containing instructions to configure a processor to perform operations comprising:
accessing an original data set having one or more fields, the original data set including an original configuration setting for one or more medical devices;
accessing a revised data set having one or more fields that correspond to the one or more fields in the original data set, the revised data set including a revised configuration setting for the one or more medical devices;
comparing the one or more fields in the revised data set with the one or more fields in the original data set;
generating a report based on the comparing that characterizes one or more differences between the one or more fields in the original data set and the one or more fields in the revised data set, the one or more differences having formatting representative of the difference; and
providing data characterizing the report.

17. The non-transitory computer-readable medium of claim 16, wherein the one or more differences includes one or more new fields present in the revised data set that are absent from the original data set, and
wherein the report displays the one or more new fields and a value associated with each of the one or more new fields.

18. The non-transitory computer-readable medium of claim 16, wherein the one or more differences includes one or more deleted fields absent from the revised data set that are present in the original data set, and
wherein the report displays the one or more deleted fields and a value associated with each of the one or more deleted fields.

19. A system comprising:
a processor; and
a memory, wherein the processor and the memory are configured to perform operations comprising:
accessing an original data set having one or more fields, the original data set including an original configuration setting for one or more medical devices;
accessing a revised data set having one or more fields that correspond to the one or more fields in the original data set, the revised data set including a revised configuration setting for the one or more medical devices;
comparing the one or more fields in the revised data set with the one or more fields in the original data set;
generating a report based on the comparing that characterizes one or more differences between the one or more fields in the original data set and the one or more fields in the revised data set, the one or more differences having formatting representative of the difference; and
providing data characterizing the report.

20. The system of claim 19, wherein each of the one or more fields in the original data set are associated with a value,
wherein each of the one or more fields in the revised data set is associated with a value,
wherein the comparing further compares the value associated with each of the one or more fields in the revised data set with the value in the corresponding one or more fields in the original data set,
wherein the one or more differences includes a value change, the value change indicating that the value associated with any of the one or more fields in the revised data set is different from the value in the corresponding one or more fields in the original data set, and
wherein the report displays the value of the one or more fields in the revised data set associated with the value change with formatting representative of a value change.
